(19) United States
(12) Patent Application Publication
(10) Pub. No.: US 2011/0318440 A1
(43) Pub. Date: Dec. 29, 2011

(54) DIE PLATE FOR AN UNDERWATER TYPE PELLETIZER

(76) Inventors: Ludwig Zollitsch, Korntal (DE); Ulrich Kreuz, Erdmannhausen (DE)

(21) Appl. No.: 12/846,461

(22) Filed: Jul. 29, 2010

(30) Foreign Application Priority Data
Jun. 28, 2010 (DE) 10 2010 030 614.2

(51) Int. Cl. B29C 47/12

(52) U.S. Cl. 425/67

(57) ABSTRACT

The invention relates to a die plate (1, 1a) for a pelletizer head (10) of an underwater pelletizer for pelletizing plastics. The die plate (1, 1a) has through openings (3) for the passage of plastic melt and nozzles (2) inserted in the through openings (3). At the exit-side ends of the through openings (3) there is provided respectively a shoulder (5) which projects into the respective through opening (3). The nozzles (2) are narrowed at their exit-side end regarding the outside cross-section and with the thus formed front surfaces (4) rest on the shoulders (5) of the through openings (3). The front surfaces (4) of the nozzles (2) can in particular be configured essentially spherically, so that the contact surface (7) and thereby a heat flow between the nozzles (2) and the die plate (1, 1a) is minimal.

The invention relates to a die plate for a pelletizer head of an underwater pelletizer, nozzles for a pelletizer head of an underwater pelletizer which are especially adapted for use together with such a die plate, and an underwater pelletizer with such a die plate and/or such nozzles.

Underwater pelletizers serve to produce plastic pellets. For this purpose the plastic is pressed through the die plate of a pelletizer head into a water chamber. By means of a rotating cutting head the plastic strands exiting from the through openings of the die plate are severed, wherein the thus produced plastic pellets are guided away with the cooling water streaming through the water chamber.

The temperature of the plastic melt at the exit end of the through openings is of special importance, since the plastic melt must solidify only after exiting. A solidification of the melt already in the through openings causes an irregular melt flow or even the interruption of the melt flow. Due to such disturbances it may be required to shut down the complete pelletizing system. In particular when starting up the pelletizing system it is imperative to prevent this phenomenon, which is also called “freezing”.

When starting up the underwater pelletizer the simultaneous streaming in of the cooling water into the water chamber and the exiting of the plastic melt must be paid attention to. If the cooling water streamed around the die plate too early, the consequence would be a strong cooling of the nozzles, thus causing the melt entering the nozzles to solidify immediately. If, on the other hand, the plastic melt exited the nozzles without immediate cooling, the die plate and the cutting head would be smeared with plastic melt. Therefore usually a bypass conduit is provided for the cooling water, so that, when starting up, cooling water already flowing through the bypass conduit only has to be diverted into the water chamber, and is thus available at the right time. Due to the same problem, an interruption of the melt flow during operation is usually impossible without draining the cooling water, since the plastic melt in the nozzles would equally solidify immediately.

A clogging of individual nozzles during operation has the disadvantage that the pellet length changes, inhomogeneous pellets can be produced and the pressure ratios in the pelletizer head change. The pressure increases due to the higher flow rate, and the increasing viscosity of non-Newtonian fluids at a greater shear rate.

In case the contact pressure is generated by an extruder, the backed-up length of the melt grows as the head pressure increases, and the product can be thermally damaged.

The clogging of individual nozzles consequently has a negative effect on the plastic melt and the pelletizing process.

In the state of the art different solutions are described to guide the plastic melt in the through openings or nozzles in such a fashion that their surface practically has melt temperature until the time of exiting. For this purpose the die plates are usually heated, which however leads to a strong heat gradient at the exit side of the die plate which is in contact with the cooling water.

In order to prevent a heat flow from the nozzles to the die plate which is in contact with water, i.e. a cooling of the nozzles through the adjacent cooling water. AT 505 845 B1 suggests to support the nozzles in a contact-free fashion in the through openings of the die plate, wherein the direct contact of the nozzles with the die plate is prevented by an elastic sealing material. The sealing material rests on a front side of the nozzles and is propped against a shoulder at the exit-side end of the through openings which projects into the through openings. The nozzles furthermore have on each of their insides a bar which projects beyond the front surface, in order to prevent the contact of the hot plastic melt streaming through the nozzles with the sealing material. Furthermore the nozzles are narrowed in the direction of their exit end, so that they have no lateral contact with the insides of the through openings.

In this fashion the heat flow from the nozzles to the die plate can be reduced in such a fashion that the above-mentioned problems are largely eliminated. In particular in such a construction type a bypass conduit for the cooling water is no longer mandatory, since said cooling water can be let into the water chamber already shortly before the exit of the plastic melt into the water chamber without an excessive cooling of the nozzles. It is thus also possible to briefly interrupt the melt flow during operation and restart it without the freezing of the nozzles.

However, the elastic high-temperature seals required for this purpose are relatively expensive and have a limited thermal resilience.

Die plates have to be cleaned frequently, which is usually done thermally (e.g. pyrolysis oven).

Since the elastic seals do not withstand the cleaning temperatures, skilled staff has to dismount the die plate, clean it and furnish it with new seals after cleaning. The maintenance of the system is thereby considerably complicated.

Therefore it is the object of the present invention to provide a die plate and nozzles for an underwater pelletizer which minimize a heat flow between the die plate and the nozzles and in doing so have a reliable sealing effect, however which are easier to maintain and more cost-effective than the known apparatus.

This object is achieved by a die plate and nozzles for a pelletizer head of an underwater pelletizer in accordance with the independent claims. Further developments and advantageous embodiments are specified in claims dependent on these.

According to the invention it is provided that the nozzles rest on the shoulders of the through openings with their respective front surface which is formed by the narrowing of the outside cross-section of the nozzles at their exit-side end. In this fashion no separate sealing material is required, since the sealing takes place through the direct contact of the nozzles with the shoulders of the through openings. In the simplest case thus a metallic contact is given between the nozzles and the shoulders of the through openings. Since the nozzles are narrowed regarding the outside cross-section at their exit end, and are in contact with the die plate regarding merely their front surfaces, the contact surface is small, so that also the heat flow between the nozzles and the die plate; which is in contact with the cooling water, is little. The disadvantages described at the outset, in particular the freezing of the nozzles, are thereby prevented. Furthermore the maintenance is facilitated, since no separate sealing material has to be handled and, if required, replaced. Since sealing material can be omitted, the costs can be reduced.

Advantageously, the exit-side front surfaces of the nozzles are oblique, so that the contact surface with the shoulders of the through openings is minimized. Oblique means that the front surfaces of the nozzles are not parallel to the exit side of the die plate, above which the cutting head rotates. Ideally, the nozzles and the shoulders touch each other only on a circle line. Due to the very small contact surface the heat flow from the die plate to the nozzles is minimized, so that a solidification of the plastic melt in the nozzles can be prevented. Furthermore, through the oblique exit-side front surfaces the sealing effect between the nozzles and the shoulders is improved. For due to the minimal contact surface the force with which the nozzles are pressed against the shoulders is very great per contact-surface area.

Preferably the front surfaces of the nozzles are convex, particularly preferably configured essentially spherically, meaning that the front surfaces are not beveled linearly, but, viewed in cross section, essentially follow a curve. For example the front surface of the nozzle essentially corresponds to a hemispherical surface. However, the front surface can also correspond to a surface of any desired spherical segment, with the surface always necessarily being interrupted by the exit opening of the nozzle. By providing an essentially spherical front surface the sealing effect can be further improved, since the gradient of the nozzles' front surfaces in the area around their respective exit opening is relatively flat and consequently a contact with the shoulder is possible at a very flat angle.

The axially frontmost area of the front surfaces can however also be configured flatly. For example it can be advantageous to flatten the nozzles at their exit-side end, in order to bring them all to a uniform length. Provided that this area is kept correspondingly small, the line-shaped contact is essentially maintained. Provided that the shoulder is simultaneously configured level with the nozzles at least in the contact area, that is parallel to the flat, frontmost front-surface area of the nozzle, advantageously a relative movement in radial direction is possible, which can e.g. compensate for deformations due to temperature changes.

Preferably, however, not only the front surfaces of the nozzles have a convex, preferably essentially spherical shape, but also the surfaces of the shoulders of the through openings have a concave, preferably essentially spherical shape. In this fashion ideally there is given a line contact along a circular line, with the convex front surfaces of the nozzles and the concave surfaces of the shoulders of the through openings meeting each other at a relatively flat angle. Also thereby, while maintaining the sealing effect, small radial displacements of the nozzles relative to the die plate can be accommodated, which can take place for example through thermal movements.

By configuring the shoulders with a concave shape the stability of the shoulders is substantially increased, so that the thickness of the shoulders at the passage cross-section can be implemented correspondingly small. In particular the front surfaces of the nozzles and the shoulders have different radii of curvature, with the radius of the front surfaces of the nozzles of course being smaller than the radius of curvature of the shoulders.

The nozzles are supported in the nozzle plate preferably in such a fashion that they are axially adjustable in relation to the die plate. In particular the nozzles can be screwed into the die plate by means of a thread. Thereby each nozzle can be individually pressed against the shoulders of the through openings, so that for every nozzle in every through opening the sealing effect is ensured. Axial tolerances regarding the dimensions of the nozzles and the die plate can thus be compensated for in an easy fashion, so that a flattening of the nozzles at the exit end for the purpose of tolerance compensation can be omitted. In this fashion an ideal line pressing can be achieved axially between the nozzles and the die plate. The exchangeability of all parts is guaranteed.

In a preferred embodiment the die plate is formed by a nozzle plate for accommodating the nozzles and a cutting plate mounted on the exit side in front of the nozzle plate, with the shoulders being configured in the cutting plate. The cutting plate serves to protect the pelletizer head against strong wear through the rotating cutting head and can be configured rather thin. The surface of the cutting plate, on which the cutting head rotates, can additionally be furnished with a wear protection layer. In particular there can be provided a gap between the cutting plate and the nozzle plate, the gap serving to insulate the pelletizer head against a heat dissipation via the die plate into the cooling water of the underwater pelletizer.

It is furthermore advantageous to furnish at least the shoulders of the through openings of the die plate or cutting plate with a coating consisting of a material that is softer than the die plate/cutting plate itself. It is sufficient to coat only the shoulders, but e.g. for production-technical reasons it can also be provided to furnish the complete die plate/cutting plate with such a coating from one side. Through the softer material in the area of the contact surface with the nozzles the axial sealing can be further improved. Such a coating can also accommodate radial thermal movements. As materials for example a metal that is softer than that of the die plate/cutting plate or also plastic come into question.

During operation the cutting plate can arch toward the outside, i.e. in the direction of the water chamber. This can happen when, due to their heating, the nozzles extend axially more strongly than the nozzle plate and/or the fixing screws between the cutting plate and the nozzle plate. Since the nozzles are in contact with the cutting plate via the shoulders of the through openings, they press correspondingly against the cutting plate. However, on the outward side of the cutting plate there rotates the cutting head in order to produce the pellets. Through the increased pressure of the cutting head caused by the arching the wear is increased.

In order to reduce or prevent an arching of the cutting plate against the rotating cutting head, it can be advantageous to clamp the cutting plate centrally in the direction of the nozzle plate. In this fashion an arching of the cutting plate, which is usually fixed only at the edge, is prevented in the direction of the cutting head. The thermal bridge thus created is negligible, since the nozzles are usually disposed in a circular arrangement at a sufficient distance to the center of the die plate or cutting plate. The central fixation of the cutting plate consequently does not have a negative effect on the melt flow in the nozzles.

Alternatively or additionally it is possible to configure the inlet side of the cutting plate so that it is convex. A possibly occurring arching due to the axially extending nozzles is compensated for by the convexity due to the greater material strength.

In order to accommodate an axial extension of the nozzles it can also be provided to support the nozzles in an axially spring-loaded fashion against the shoulders. The cutting plate can be screwed to the nozzle plate against springs, for example disk springs. In doing so, the springs are preferably disposed below the screw head. In order to achieve a good compensation of the axial thermal extension of the nozzles, the springs can be pretensioned through screwing in the nozzles. The spring constant is preferably chosen low, so that a changing spring travel upon a thermally induced change of length of the nozzles has no substantial effect on the spring force. Since the change in spring force is consequently small, an arching of the cutting plate against the cutting head during operation is prevented, so that the wear of the knives is reduced.

The described die plate and the nozzles are in particular adapted for use in an underwater pelletizer. A great tightness is achieved between the nozzles and the die plate at a simultaneously low heat flow. In particular the problem of the freezing of the nozzles described at the outset is thus prevented.

The invention is hereinafter described by way of example with reference to the accompanying drawings. The figures are described as follows:

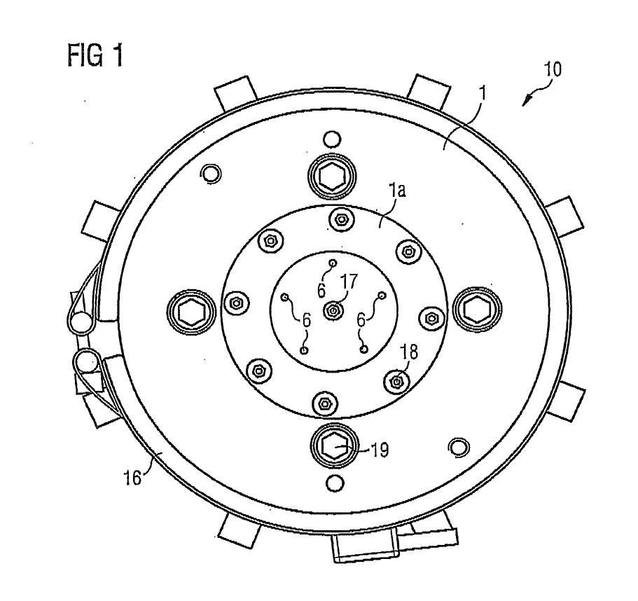

FIG. 1 a pelletizer head of an underwater pelletizer in a top view,

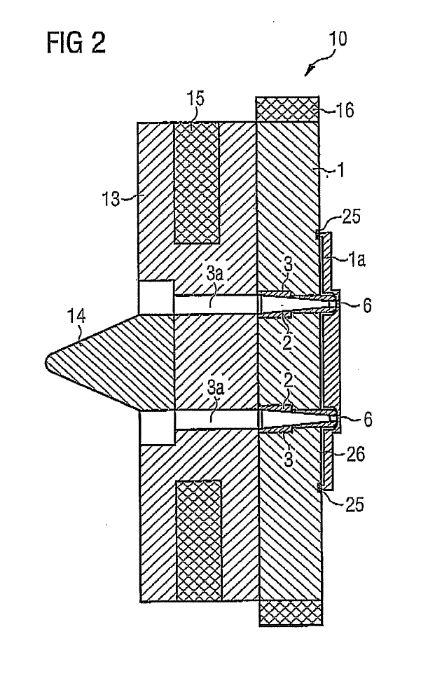

FIG. 2 the pelletizer head of FIG. 1 in a sectional view,

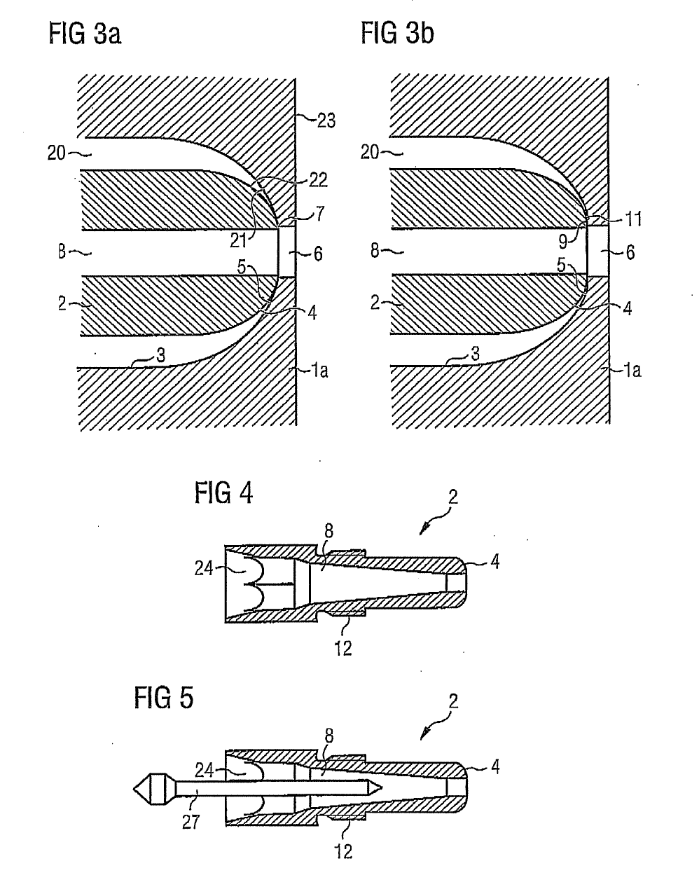

FIGS. 3a and 3b detail views of two embodiments of a contact area between a nozzle and a shoulder in a through opening in a sectional view,

FIG. 4 a nozzle with thread in a sectional view, and

FIG. 5 a nozzle like in FIG. 4 with a heat-conductor pin.

FIG. 1 shows a pelletizer head 10 for an underwater pelletizer in a top view. The represented side of the pelletizer head 10 during operation of the underwater pelletizer is in contact with cooling water which transports the plastic pellets away. The die plate is formed by a nozzle plate 1 and a cutting plate 1a and is surrounded by a heating band 16 which supplies the die plate with heat energy, in order to keep the die plate at temperature. The use of a heating band has the advantage in comparison to heating cartridges that it can be removed easily in maintenance work requiring a removal of the die plate from the pelletizer head 10.

The die plate has five circularly arranged exit holes 6, through which the plastic melt exits into the (not represented) water chamber. The exit holes 6 here are in particular formed by the cutting plate 1a, on which there rotates a cutting block, in order to produce the pellets. The cutting plate 1a consists of a material which is better protected against wear through the cutting block sliding over it than the nozzle plate 1. The cutting plate la is connected via connecting elements 18, for example screws, to the nozzle plate 1 which in turn is connected via connecting elements 19, for example screws, to a base component of the pelletizer head (not represented in FIG. 1). Below the connecting elements 18 there are provided springs, in particular disk springs, so that a desired tensioning force is adjustable. The cutting plate 1a has a central fixing device 17, which prevents an arching of the cutting plate 1a in the direction of the cutting block.

In FIG. 2 the pelletizer head 10 of FIG. 1 is represented in a sectional view. The plastic melt is first divided into several partial streams on the inlet side of the pelletizer head 10 by means of a cone 14. Through channels 3a in the base component 13 the melt streams arrive at through openings 3 in the die plate, which is formed by the nozzle plate 1 and the cutting plate 1a. The base component 13 is heated by means of heating cartridges 15, so that the plastic melt in the channels 3a does not solidify. Optionally, the cone 14 can be fixed to the base component 13 in three places in the fashion of a torpedo, so that instead of individual channels 3a one segmented circular channel is formed.

The die plate is arranged on the base component 13 and—as already described in connection with FIG. 1—surrounded by the heating band 16. In order to protect the die plate against wear, in the area of the exit holes 6 the cutting plate 1a is arranged.

In the through openings 3, which in this embodiment lead through the nozzle plate 1 and the cutting plate 1a, there are arranged nozzles 2 through which the plastic melt is guided. The cutting plate 1a is mounted to the nozzle plate 1 by means of the connecting elements 18 (FIG. 1) and supported on bearings 25, so that there remains a gap 26 between the nozzle plate 1 and the cutting plate 1a. The bearings 25 can be made e.g. of ceramics such as zirconium oxide. Through the gap 26 and the bearings 25 a heat flow from the die plate to the cooling water, which contacts the cutting plate 1a, is reduced.

In FIGS. 3a and 3b detail views of a contact area between a front surface 4 of a nozzle 2 and a shoulder 5 of a through opening 3 are represented. The shoulder 5 is formed in the cutting plate 1a and projects into the through opening 3. Due to the chosen outside diameter of the nozzle 2, which is narrowed at its exit end, there is no contact between the outside circumference of the nozzle 2 and the through opening 3. The resulting gap 20 provides a heat insulation, so that in this way no heat is conducted from the nozzle 2 to the cutting plate 1a which is in contact with cooling water.

In the embodiment represented in FIG. 3a both the front surface 4 of the nozzle 2 and the shoulder 5 in the through opening 3 are configured spherically. A contact is give merely n in the form of an ideally linear contact surface 7, so that the heat flow between the nozzle 2 and the cutting plate 1a is minimal. In particular for this purpose the passage diameter at the outlet of the nozzle 2 is smaller than the adjacent diameter of the exit opening 6 in the cutting plate 1a. A solidification of the plastic melt in the passage opening 8 of the nozzle 2 can thus be prevented. Moreover, the reduction of the heat flow into the cooling water also economizes energy, since less heating output is lost.

In case melt solidifies nevertheless in the exit opening 6 due to an interruption of the melt stream, this plug, due to its small size, is simply pushed out by following plastic melt. The thickness of the shoulder 5 for example can amount to merely 1 mm in the area of the exit opening 6. Despite the delicate end of the shoulder 5 a high mechanical stability is guaranteed, since the cross-section of the shoulder 5 due to the spherical shape increases very strongly as the distance from the exit opening 6 grows.

Due to the spherical implementation of the front surface 4 of the nozzle 2 on the one hand and of the shoulder 5 on the other hand, and due to the associated flat angle in the area of the common contact surface 7 a good sealing effect with great sealing force is achieved. In order to further improve the sealing effect, a coating 21 can be provided in the area of the shoulder 5 or for production reasons on the complete surface, the coating consisting of a softer material than the cutting plate 1a, such as for example a softer metal or also a heat-resistant plastic. Additionally, also the front surface 4 of the nozzle 2 can be furnished with a coating 22. In particular axial displacements due to thermal movements can thus be accommodated. A coating of a thickness of 0.1 mm can be completely sufficient to accommodate thermal deformations, for example through the cooling of the die plate, in the area of e.g. 0.01 mm. Additionally a wear-protection layer 23 can be provided on the cutting plate 1a, in order to protect the cutting plate 3 against the cutting block sliding on it.

FIG. 3b shows an embodiment in which the spherical front surface 4 of the nozzle 2 and the spherical shoulder 5 of the cutting plate 1a each have a flat area 9 or 11. By providing a flat area parallel to a radial plane a sliding of the nozzle 2 on the shoulder 5 is rendered possible, so that radial displacements can be accommodated better. The flat area 9, 11 can for example have a width of 0.2-0.3 mm, with said area adjoining the through opening 8 and the passage opening 6 both on the front surface 4 of the nozzle 2 and on the shoulder 5. Otherwise the embodiment represented in FIG. 3b corresponds to that of FIG. 3a.

FIG. 4 finally shows a nozzle 2 having a thread 12. By means of the thread 12 the nozzle 2 can be screwed into the nozzle plate and thus be pressed with its front surface 4 against the shoulder 5 in the respective through opening 3 of the nozzle plate. The nozzle 2 can for example have a hexagon socket 24 for screwing in. In this fashion each nozzle 2 can be adjusted individually, for example in maintenance works or also when setting up a pelletizing system, so that smaller tolerances are overcome particularly regarding the axial dimensions of the nozzles 2, and the desired contact pressure can be applied on the front surface 4.

FIG. 5 shows a special embodiment of the nozzle 2 of FIG. 4. Into the passage opening 8 of the nozzle 2 there extends a heat-conductor pin 27 which heats the melt in the nozzle 2 until shortly before its exit.

1. A die plate for a pelletizer head (10) of an underwater pelletizer for pelletizing plastics, having through openings (3) for the passage of plastic melt and nozzles (2) inserted in the through openings (3), wherein the through openings (3) at their exit-side end respectively have a shoulder (5) protruding into the through opening (3) and the nozzles (2) are narrowed at their exit-side end regarding their outside cross-section while forming a front surface (4), characterized in that the nozzles (2) With their front surfaces (4) rest on the shoulders (5) of the through openings (3).

2. The die plate according to claim 1, with the front surfaces (4) of the nozzles (2) being configured obliquely, preferably convexly and particularly preferably essentially spherically.

3. The die plate according to claim 2, with an axially frontmost area (9) of the front surfaces (4) being configured flatly.

4. The die plate according to claim 2, with both the front surfaces (4) of the nozzles (2) and the shoulders (5) of the through openings (3) being configured respectively essentially spherically, and with the radii of curvature of the front surfaces (4) and the shoulders (5) being different.

5. The die plate according to claim 1, with the shoulders (5) of the through openings (3) having a central surface portion (11) parallel to a radial plane.

6. The die plate according to claim 1, with the nozzles (2) in the die plate (1, 1a) being supported in such a fashion, in particular screwed in, that they are axially adjustable relative to the die plate (1, 1a).

7. The die plate according to claim 1, with the die plate (1, 1a) having at least on the shoulders (5) of the through openings (3) a coating. (21) of a softer material than that of the die plate (1, 1a).

8. The die plate according to claim 1, with the die plate (1, 1a) having a nozzle plate (1) for accommodating the nozzles (2) and a cutting plate (1a) which is mounted on the exit side in front of the nozzle plate (1) and in which the shoulders (5) are configured.

9. The die plate according to claim 8, with the cutting plate (1 a) being adapted to being clamped centrally (17) in direction of the nozzle plate (1).

10. The die plate according to claim 8, with the cutting plate (1a) being configured convexly on the inlet side.

11. The die plate according to claim 1, with the nozzles (2) being supported in an axially spring-loaded fashion against the shoulders (5).

12. A nozzle for a pelletizer head (10) of an underwater pelletizer for the passage of plastic melt, characterized in that its front surface (4) on the exit side is configured convexly, preferably essentially spherically, with an axially frontmost area (9) of the front surfaces (4) being configured flatly, if required.

13. A nozzle for a pelletizer head (10) of an underwater pelletizer for the passage of plastic melt, preferably according to claim 12, characterized in that the nozzle (2) is adapted to being axially adjusted relative to a die plate (1, 1a) of a pelletizer head (10) of an underwater pelletizer.

14. The nozzle according to claim 13, with the nozzle (2) having a thread (12) for the purpose of axial adjustability.

15. An underwater pelletizer for pelletizing plastics, comprising a die plate (1, 1a) according to claim 1 and/or nozzles (2) according to claim 12.
